(19) United States
(12) Patent Application Publication
(10) Pub. No.: US 2022/0324380 A1
(43) Pub. Date: Oct. 13, 2022

(54) SYSTEM FOR ENHANCED CONSPICUITY OF DELIVERY VEHICLES

(71) Applicant: ESS-HELP, INC., Houston, TX (US)

(72) Inventors: JOHN ZACHARIAH COBB, SEABROOK, TX (US); DANIEL ANTHONY TUCKER, Santee, CA (US); DAVID M. TUCKER, Katy, TX (US); STEPHEN T. POWERS, Houston, TX (US); AUSTIN REECE TUCKER, Katy, TX (US); KENNETH E. WAGNER, Broken Arrow, OK (US); MIKE INCORVAIA, Hendersonville, TN (US)

(21) Appl. No.: 17/718,636

(22) Filed: Apr. 12, 2022

Related U.S. Application Data
(60) Provisional application No. 63/174,019, filed on Apr. 12, 2021.

(51) Int. Cl. B60Q 9/00; B60Q 1/48; B60Q 1/34; B60Q 1/52

(52) U.S. Cl. CPC B60Q 9/00; B60Q 1/486; B60Q 1/34; B60Q 1/52

(57) ABSTRACT

A microcontroller is in operative control of the left and right turn signal lamps, a park selector indicator input is communicatively coupled to the microcontroller to indicate when a vehicle is placed in park. An ignition switch position indicator is communicatively coupled to the microcontroller to indicate when the vehicle ignition switch is on or off. A hazard lamp switch activates the microcontroller to flash the left and right turn signal lamps together a standard flash rate, and a high conspicuity switch that activates the microcontroller to flash the left and right turn signal lamps together at a high conspicuity rate when the hazard lamp switch is activated, and the vehicle is in park or the ignition is off.

### CROSS-REFERENCE TO RELATED CASES

This application claims the benefit of U.S. provisional patent application Ser. No. 63/174,019, filed on Apr. 12, 2021, and incorporates such provisional application by reference into this disclosure as if fully set out at this point.

### FIELD OF THE INVENTION

This disclosure relates to vehicle lighting in general and, more specifically, to vehicle lighting with increased conspicuity for delivery vehicles.

### BACKGROUND OF THE INVENTION

Delivery drivers and delivery vehicles are susceptible to being struck by oncoming traffic while stopped on roadways to deliver packages. As delivery volumes continue to rise, the safety challenge is growing for the stopped delivery drivers and drivers and occupants of moving vehicles, with whom they share the road.

There is a large and growing problem in the US with vehicles and their occupants on or near the roadway being struck by other vehicles. Every year almost 15,000 injuries and fatalities and $9 billion of comprehensive economic impact are caused due to disabled or vulnerable vehicles on US highways, freeways, and large thoroughfares. In addition, delivery vehicles making frequent stops, temporarily parked on roadsides, while dropping off packages are also highly vulnerable to being struck by oncoming traffic.

Unchanged since 1951, current hazard flash rates of 1.0-2.0 Hz were established under the limitations of legacy incandescent bulbs and control relays rather than Human Factors science.

What is needed is a system and method for addressing the above and related issues.

### SUMMARY OF THE INVENTION

The invention of the present disclosure, in one aspect thereof, comprises a system including at least front and rear left turn signal lamps, at least front and rear right turn signal lamps, and a microcontroller in operative control of the left and right turn signal lamps. The system includes a park selector indicator input communicatively coupled to the microcontroller to indicate when a vehicle is placed in park and an ignition switch position indicator communicatively coupled to the microcontroller to indicate when the vehicle ignition switch is on or off. A hazard lamp switch that activates the microcontroller to flash the left and right turn signal lamps together a standard flash rate. A high conspicuity that activates the microcontroller to flash the left and right turn signal lamps together at a high conspicuity rate when the hazard lamp switch is activated, and the vehicle is in park or the ignition is off.

In some embodiments, the microcontroller comprises a body control module. The high conspicuity rate may be perceptibly faster than the standard flash rate. In some cases, the high conspicuity rate is 4 Hertz or more and the standard rate is 2 Hertz or less.

In further embodiments, the system includes at least one auxiliary beacon on the vehicle that is activated by the microcontroller when the left and right turn signal lamps are activated at the high conspicuity rate. The at least one auxiliary beacon may comprise at least one forward facing beacon on the vehicle and at least one rearward facing beacon on the vehicle. The at least one auxiliary beacon may be flashed in synchronization with the left and right turn signal lamps.

The invention of the present disclosure, in another aspect thereof, comprises a lighting system for use on a delivery vehicle. The system includes a set of signal lights including at least a left front signal lamp, a right front signal lamp, a left rear signal lamp, and a right rear signal lamp, a microcontroller in operative control of the set of signal lights, a gear shift lever that communicates when it is in a park position to the microcontroller, an engine ignition switch that communicates when it is in an off state to the microcontroller, a hazard light switch in operative communication with the microcontroller, and a semi-automatic high conspicuity switch in operative communication with the microcontroller. The microcontroller, when it receives a first activation signal from the hazard light switch and a second activation signal from the semi-automatic high conspicuity switch, flashes the set of signal lights at a first, lower cycle rate if the gear shift lever is not in the park position and the engine ignition switch is not in the off state. The microcontroller, when it receives the first activation signal from the hazard light switch and the second activation signal from the semi-automatic high conspicuity switch, flashes the set of signal lights at a second, higher cycle rate if the gear shift lever is in the park position or the engine ignition switch is in the off state. The semi-automatic high conspicuity switch is a soft switch.

The microcontroller may comprise a body control module of the delivery vehicle. In other embodiments, the microcontroller may have operative control of the set of vehicle lights by communicating with a body control module having control over the set of vehicle lights.

The gear shift lever may communicate when it is in a park position to the microcontroller via a controller area network bus (CANBUS). The engine ignition switch may also communicate when it is in an off state to the microcontroller via the CANBUS.

In some embodiments, the system further comprises an auxiliary beacon activated by the microcontroller when the microcontroller flashes the set of signal lights at the second, higher cycle rate. In some cases, the second, higher cycle rate is at least twice as fast as the first, lower cycle rate. The second higher cycle rate may be at least 4 Hz.

The invention of the present disclosure, in another aspect thereof, comprises a system including a set of signal lights including at least a left front signal lamp, a right front signal lamp, a left rear signal lamp, and a right rear signal lamp, a microcontroller in operative control of the set of signal lights, a gear shift lever that communicates when it is in a park position to the microcontroller, a hazard light switch in operative communication with the microcontroller, and a high conspicuity switch in operative communication with the microcontroller. The microcontroller, when it receives a first activation signal from the hazard light switch and a second activation signal from the high conspicuity switch, flashes the set of signal lights at a first, lower cycle rate if the gear shift lever is not in the park position. The microcontroller, when it receives the first activation signal from the hazard light switch and the second activation signal from the high conspicuity switch, flashes the set of signal lights at a second, higher cycle rate if the gear shift lever is in the park position. The microcontroller, when it receives the first activation signal from the hazard light switch without the second activation signal from the high conspicuity switch, flashes the set of signal lights at the first, lower cycle rate regardless of input from the gear shift lever.

The microcontroller may comprise a body control module, and the second, higher cycle rate may be at least twice as fast as the first, lower cycle rate.

The invention of the present disclosure, in another aspect thereof, comprises a system including a set of signal lights including at least a left front signal lamp, a right front signal lamp, a left rear signal lamp, and a right rear signal lamp, a microcontroller in operative control of the set of signal lights, an engine ignition switch that communicates when it is in an off state to the microcontroller, a hazard light switch in operative communication with the microcontroller, and a high conspicuity switch in operative communication with the microcontroller. The microcontroller, when it receives a first activation signal from the hazard light switch and a second activation signal from the high conspicuity switch, flashes the set of signal lights at a first, lower cycle rate if the engine ignition switch is not in the off state. The microcontroller, when it receives the first activation signal from the hazard light switch and the second activation signal from the high conspicuity switch, flashes the set of signal lights at a second, higher cycle rate if engine ignition switch is in the off state. The microcontroller, when it receives the first activation signal from the hazard light switch without the second activation signal from the high conspicuity switch, flashes the set of signal lights at the first, lower cycle rate regardless of the off state of the ignition switch.

The microcontroller may comprise a body control module, and the second, higher cycle rate may be at least twice as fast as the first, lower cycle rate.

### BRIEF DESCRIPTION OF THE DRAWINGS

FIG. 1 is a front perspective view of a delivery vehicle employing a high conspicuity lighting system according to aspects of the present disclosure.

FIG. 2 is a rear perspective view of a delivery vehicle employing a high conspicuity lighting system according to aspects of the present disclosure.

FIG. 3 is a perspective view of an interior of a delivery vehicles a employing a high conspicuity lighting system according to aspects of the present disclosure.

FIG. 4 is a simplified schematic diagram of a high conspicuity vehicle lighting system according to aspects of the present disclosure.

FIG. 5 is a flow chart illustrating a semi-automatic functional mode of a high conspicuity vehicle lighting system according to aspects of the present disclosure.

### DETAILED DESCRIPTION OF THE PREFERRED EMBODIMENTS

The present disclosure provides various systems and methods directed to improving warning signals, lighting conspicuity, and indication of stoppages or hazardous conditions for motor vehicles. The systems of the parent disclosure may be deployed on any motor vehicle (to include, without limitation, cars, trucks, SUVs, RVs, semi-trucks, trailers, motorcycles, and off road vehicles). However, in various embodiments the system and methods of the present disclosure are particularly advantageous for delivery vehicles.

Deployment of systems and methods of the present disclosure provide for better advanced notification and higher conspicuity of all vehicles, but particularly delivery vehicles; and represent an effective mitigation against the unique hazards and risks posed by delivery vehicles, both to drivers and delivery personnel, as well as drivers and passengers of other nearby vehicles.

While leveraging regulatory-compliant, human factors-derived lighting patterns, various solutions include application-tailored switch operation logic which allows drivers to operate their hazard lamps to greater effect from a safety perspective. Light emitting diode (LED) and electronic control technologies enable intelligent emergency communications unachievable with 20th century lighting technology.

Various embodiments of the present disclosure reflect two priorities with activation. One is compliance with State and Federal standards. High conspicuity modes may only available when the vehicle is stopped and in Park. This also minimizes annoyance to other roadway users. Standard hazard lamps or flashers may always remain fully functional and available to the driver. A second priority is ease of use. With semi-automatic activation, a driver can operate their hazard lamps without any change to current operating procedure (using the existing hazard switch), while a system according to the present disclosure does the rest. When the semi-automatic mode is activated, the vehicle will switch automatically to high-flash rate lighting upon engagement of park.

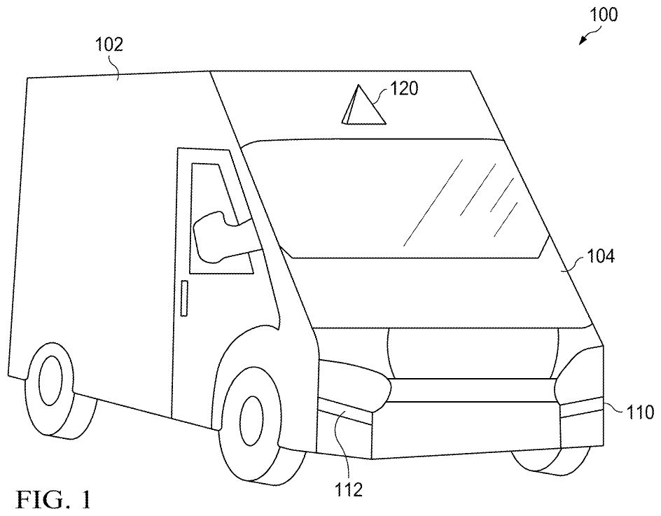

Referring now to FIG. 1, a front perspective view of a delivery vehicle 100 employing a high conspicuity lighting system according to aspects of the present disclosure is shown. Here again, nearly any vehicle could be equipped with a system according to the present disclosure. However, as one of skill in the art will appreciate with the benefit of this disclosure, systems and methods herein may find particularly utility in the context of use on or with a delivery vehicle, and therefore delivery vehicles form the primary examples within the present disclosure.

The delivery vehicle 100 may comprise a van, truck, or other vehicle that is being employed or used as vehicle for delivering numerous packages along a route that may or may not be predetermined. The delivery vehicle 100 may be gasoline, diesel, electric, hybrid, or hydrogen powered, or based on other vehicle motive technologies. In some instances, the delivery vehicle 100 represents a vehicle being used for so-called “last mile” services where a very large van or semi-truck may not represent the most efficient use of equipment. Accordingly, the delivery vehicle 100 may represent a Ram ProMaster® van, or another vehicle of similar size and use. A vehicle such as delivery vehicle 100 might be used by companies such as FedEx®, Amazon®, UPS®, DHL® or other services.

The delivery vehicle 100 may comprise a cargo area or cargo box 102 containing freight or delivery parcels. A driver cab 104 may be integrated with the cargo box 102 or separate, depending upon the application. As a vehicle operating on public roadways, the delivery vehicle 100 includes front turn signals, including front left turn signal 110 and front right turn signal 112. As is known, these lights may be used by the driver to signal left or right turns. The turn signals 110, 112 may be visible on the left and right front corners of the vehicle 100.

In the past, turn signals 110, 112 may have utilized incandescent lamps. More modern vehicles may rely on LEDs for this application. According to the present disclosure, use of LEDs or other sufficiently quickly cycling light elements or bulbs, enables implementation of high conspicuity systems. Additionally, in the case of a vehicle originally built with incandescent turn signal lamps, these may be retrofitted, as is known in the art, to utilize LEDs. In such case, even an older vehicle or one utilizing incandescent turn lamps may be modified to operate with systems and methods of the present disclosure.

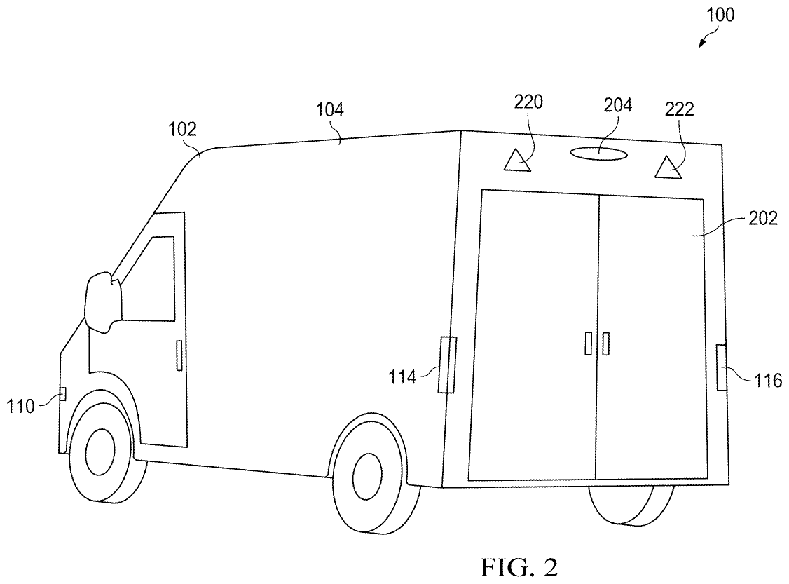

Referring now to FIG. 2, a rear perspective view of the delivery vehicle 100 employing a high conspicuity lighting system according to aspects of the present disclosure is shown. Rear turn signals 114, 116 are provided on the left rear and right rear corners of the vehicle 100, respectively. As with the front turn signals 110, 112, the rear turn signals 114, 116 may comprise LEDs or another lighting element with sufficiently fast cycle time, or may be retrofitted or upgraded accordingly.

The rear turn signals 114, 116 may also function as brake lights. In other embodiments the rear turn signals 114, 116 are separate lighting elements from the brake lights, and may or may not remain in the same housing as the brake lights. The vehicle 100 may also employ a center high mounted stop lamp (CHMSL) 204 as required by regulation.

The turn signals 110, 112, 114, 116 may also be referred to as turn indicators, signal indicators, turn lamps, indicator lamps, and the like. Unless otherwise specified this terminology is intended to encompass lighting devices that are capable of the high cycle rate or high conspicuity operation called for by systems and methods of the present applications (e.g., such as LEDs). Similarly, the CHMSL 204 is denoted as a “lamp” but may comprise an LED or other sufficiently quickly cyclable light source.

According to various embodiments of the present disclosure, the turn signals 110, 112, 114, 116 are utilized as is known in the art to indicate left or right turns based upon manipulation of a turn signal stalk inside the vehicle 100. The turn signals 110, 112, 114, 116 may also be deployed simultaneously as prior art hazard lamps based on manipulation of a hazard light switch inside the vehicle 100. When deployed as turn signals or hazard lamps, the 110, 112, 114, 116 are known to be deployed at a relatively slow rate (e.g., 1-2 Hz) as such functions were originally provided on vehicles when slower cycling incandescent bulbs were state of the art. However, when deployed in high visibility or high conspicuity modes according to the present disclosure, the turn signals 110, 112, 114, 116 cycle at a higher rate, such as 4-6 Hz, which Applicant's research has shown to capture attention more quickly, and to be more likely to maintain driver attention even if other distractions or unfavorable conditions are present.

In order to further increase light output in particular situations, in addition to reliance on turn signals 110, 112, 114, 116, the CHMSL 204 may be employed. The CHMSL may be cycled on and off at a higher rate (e.g., 4-6 Hz) along with the turn signals 110, 112, 114, 116 when high conspicuity operations are in effect.

Systems according to the present disclosure may also utilize auxiliary beacons such as front facing beacon 120 and/or one or more rear facing beacons such as left rear beacon 220 and right rear beacon 222. In some embodiments, multiple front facing beacons may be utilized. In some embodiments, only a single rear beacon is utilized. The beacons 120, 220, 224 may have a specific shape, such as a caution symbol, or may be rounded or point light sources. When employed along with high visibility operation of turn signals 110, 112, 114, 116, beacons 120, 220, 224 may operate at a similar high frequency or cycle rate (e.g., 4-6 Hz) as turn signals 110, 112, 114, 116.

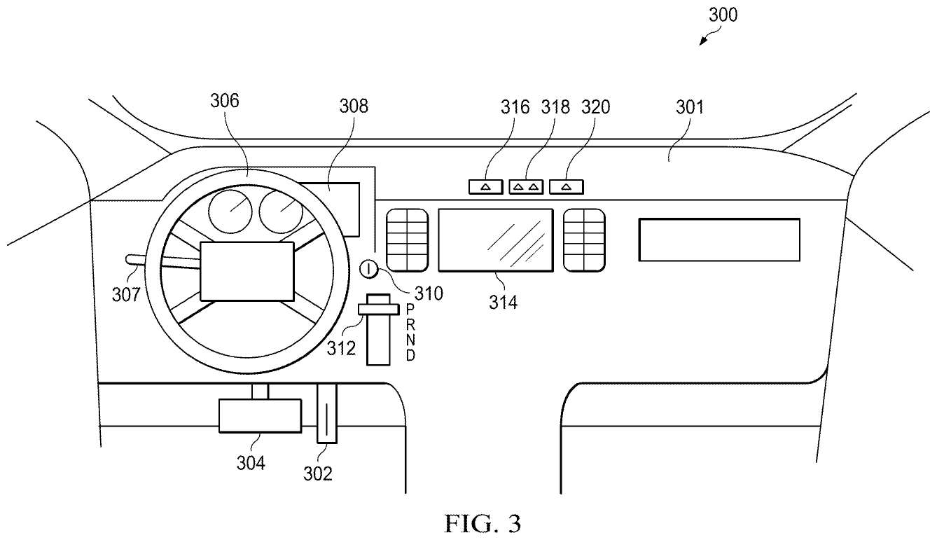

Referring now to FIG. 3, is a perspective view of an interior 300 of a delivery vehicle a employing a high conspicuity lighting system according to aspects of the present disclosure is shown. The interior 300 is from the viewpoint of the driver or passenger position within the cab 104 of the delivery vehicle 100. The interior 300 may include a dashboard 301 and controls with which a driver would be familiar. An accelerator pedal 302 and a brake pedal 304 are available below a steering wheel 306. Driving controls are shown in FIG. 3 as in a vehicle designed for the North American market (e.g., left-hand drive). However, systems and methods of the present disclosure are equally deployable in a right-hand drive vehicle.

A signal light stalk 307 may be provided near the steering wheel and an instrument panel 308 may be viewed through or around the steering wheel 306. An ignition switch 310 may control the on/off/start state of the vehicle 100 and may be a physical or manually keyed switch, or may be a button used as part of a smart key system. A gear selector 312 may be placed on the dash 301, on the steering column, on a middle console, or elsewhere. The gear selector 312 may be, without limitation, a lever, a button, a set of buttons, or a dial, and may be used to select between Park, Reverse, Neutral, and Drive and other forward gears as known in the art.

The vehicle interior 300 may include a multifunction panel 314 that may be used for display and/or input. In some embodiments, systems of the present disclosure utilize soft switches. Such switches may be displayed for selection on the multifunction panel 314, for example.

As known in the art, a hazard flasher button 316 may be provided in a convenient location. This allows the driver or a passenger to activate standard emergency flashers, which may utilize turn signals 110, 112, 114, 116 in a known, low speed or low cycle (e.g., 1-2 Hz) flash. As explained further below, the hazard flasher button 316 can also be employed as a component of the high conspicuity systems and methods of the present disclosure.

System of the present disclosure may also include an additional high conspicuity switch or button 318. This may be utilized to activate a system according to the present disclosure to deploy turn signals 110, 112, 114, 116 and/or beacons 120, 220, 224 in a high conspicuity manner (for example a fast flash rate of 4-6 Hz). In some cases, the hazard flasher button 316 must be activated before the high conspicuity button 318 will activate the higher flash rate. In other cases, the high conspicuity button 318 may activate the high speed flash of turn signals 110, 112, 114, 116 and/or beacons 120, 220, 224, but the hazard flasher button 316 serves as an override and returns the operation of the turn signals 110, 112, 114, 116 to the ordinary 1-2 Hz cycle rate.

In some embodiments, a semi-automatic mode button 320 is provided that overrides the operation of the hazard flasher button 318 to deploy turn signals 110, 112, 114, 116 and/or beacons 120, 220, 224 in high conspicuity mode when certain other conditions are met, as described further below. In some embodiments, the high conspicuity button 318 may operate to place the system in semi-automatic mode as the only way to deploy high conspicuity operations. In such case, a separate semi-automatic button 320 may not be provided.

It should be understood that one or more of the buttons 316, 318, 320 may be replaced with switches or other controls as are known in the art. One of more of these may be a soft switch or button on the multifunction panel 314 instead of, or in addition to, being a physical control on the dash 301 or elsewhere.

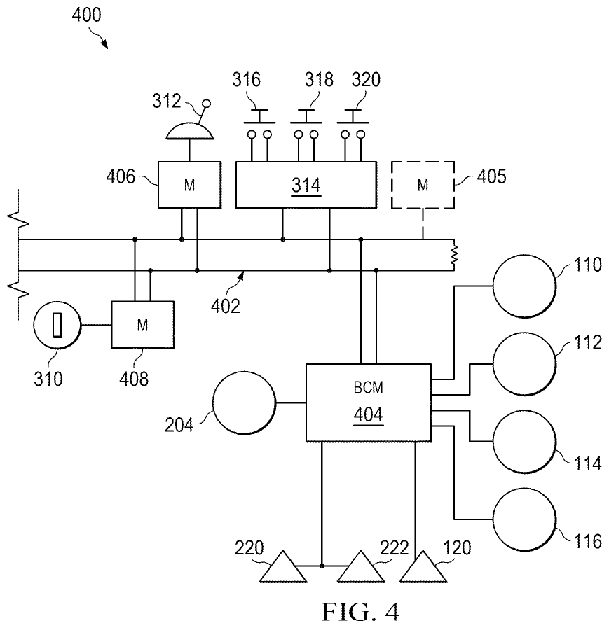

Referring now to FIG. 4, is a simplified schematic diagram 400 of a high conspicuity vehicle lighting system according to aspects of the present disclosure is shown. In some embodiments, the system 400 utilizes a controller area network bus (CANBUS) to communicate with disparate components and systems throughout the vehicle. However, components can also be separately connected or utilize other bus systems.

In some embodiments, primary control and operation of the system 400 resides on a body control module (BCM) 404 associated with the vehicle (e.g. vehicle 100). A BCM is an electronic control unit that topically controls body functions such as lighting, door locks, etc. (as opposed to, for example, engine, transmission, or other drive train operations). A BCM may comprise microcontrollers or other silicon chips implementing the various functions associated with BCM. Utilizing the BCM 404 allows auto makers to deploy systems and methods of the present disclosure with at least some hardware that is already present in the vehicle (most vehicles utilize a BCM for many functions already). Thus, minimal cost increase is encountered for a substantial increase in safety. In a case where activation and control of the high conspicuity system 400 is performed on a multifunction panel 314, additional hardware cost approaches zero, as most, if not all, new vehicles already have multifunction display panels.

As shown, the BCM 404 has operative control over the turn signals 110, 112, 114, 116, CHMSL 204, and beacons 120, 220, 222. As is known in the art, relays, pullup resistors, and other connections allowing the BCM 404 to properly control relevant lighting are understood to be deployed where needed, but are not shown in the simplified schematic diagram of FIG. 4.

In other embodiments, it may be desirable to have control of the system 400 on a separate microcontroller from the BCM 404, in which case such separate controller would stand-in for the BCM 404 as shown. Alternately, the BCM 404 remains in complete control of some or all of the lights of the vehicle, but takes at least some commands from a high conspicuity system controller, shown as optional microcontroller 405. Commands may be relayed via the CANBUS 402, via a separate direct connection to the BCM 404, wirelessly, or utilizing another connection or method. A hybrid system is also contemplated where the BCM controls turn signals 110, 112, 114, 116 based at least partially on commands received from microcontroller 405, which also directly controls beacons 120, 220, 222.

One of skill in the will may have numerous ways to program or reprogram BCM 404 and/or optional microcontroller 405 to implement the functions of the systems and methods of the present disclosure. Thus, unless specified, systems and methods of the present disclosure are not limited to specific methods of implementation and may be placed in a vehicle at the time of manufacture, provided as an update, including over-the-air updates, or may be physically retrofitted or adapted by a dealer or other provider.

The multifunctional panel 314 may communicate with the BCM 404 and/or microcontroller 405 via the CANBUS 314. It may receive input from buttons 316, 318, and/or 320 if these are not implemented as soft switches. If the buttons 316, 318, and/or 320 are physical controls, these may instead communicate directly with the BCM 404 or microcontroller 405 via the CANBUS 402 or by direct connection.

As discussed further below, the system 400 may evaluate certain vehicle parameters to determine when or whether to activate a high conspicuity mode. Thus, the BCM 404 (and/or microcontroller 405) may communicate with other vehicle systems or subsystems. These would include, without limitation, stability control systems, braking systems, traction control systems, accelerometers, air bag systems, vehicle telematic systems, engine controllers, transmission controllers etc. As illustrated, a transmission controller 406 communicates a position of the gear selector 312 via the CANBUS 402 to the BCM 404 and/or microcontroller 405. An engine controller 408 communicates the state of the engine and ignition switch 310 via the CANBUS 402 to the BCM 404 and/or microcontroller 405. In other embodiment, gear selector 312 and/or ignition switch 310 may communicate directly on the CANBUS 402, via other microcontroller from those shown, or directly with the BCM 404 and/or microcontroller 405.

An exemplary usage scenario with respect to systems and methods of the present disclosure may be such that at the beginning of a shift, a driver activates high conspicuity mode by activating a switch in the vehicle. In this example, the switch is a semi-auto mode switch 320, meaning that the system operates exclusively in semi-auto mode, or that the semi-auto mode was intentionally selected. This working example also presumes that the BCM 404 is the primary controller of the system (e.g., the BCM is programmed, reprogrammed, or otherwise upgraded to perform the necessary functions rather that reliance on a separate microcontroller 405). Thus, the BCM 404 receives the input from the semi-auto mode switch that semi-auto high conspicuity mode should be deployed.

During a work shift, as the driver slows down and prepares to stop along a busy roadway, he or she activates the hazard lamps using the standard hazard switch 316 installed by the vehicle manufacturer. When the hazard switch 316 is activated and the vehicle 100 is slowing to a stop, the standard hazard lights operate at their standard flash rate (e.g., 1-2 Hz). In this example, all four of the signal lights turn signals 110, 112, 114, 116 function as hazard lamps.

When the vehicle comes to a complete stop and is placed in park (as indicated to the BCM 404 by the position of gear selector 312), with ignition in either in ‘On’ or ‘Off’ (as indicated to the BCM 404 by the position of the ignition switch 310), the hazard lamps automatically switch to the higher flash rate available according to systems and methods of the present disclosure. This operation of the turn signals 110, 112, 114, 116 at a perceptibly and/or noticeably faster flash or cycle rate (e.g., 4-6 Hz rather than 1-2 Hz) is a high conspicuity mode of operation, representing a safety improvement. In an embodiment where one or more supplemental beacons 120, 220, 222 are present, these may deploy by the BCM 404 in a flashing manner at the high conspicuity rate (e.g., 4-6 Hz), and may be synchronized to the flashing of the turn signals 110, 112, 114, 116.

This conspicuity mode may remain in effect while the vehicle 100 is kept in the Park position. As the driver gets in the vehicle 100 and prepares to drive to their next stop, they shift the vehicle out of Park to Drive. This change of vehicle gears is picked up on the CANBUS 402 by the BCM 404, and it reverts the hazard lamps (turn signals 110, 112, 114, 116) back to their standard flash rate. The standard flash rate may remain in operation until the driver switches off the hazards using the standard switch 316 or stops and again places the vehicle in Park.

In various embodiments, drivers can always de-activate high conspicuity mode by using a switch (e.g., switch 318) on the instrument panel or dash 301. A standard hazard lamp lighting mode may always be available (e.g., via switch 316). In another embodiment, a high conspicuity mode may be activated by using a specific switch for this (e.g., switch 320), regardless of the position of the standard hazard switch 316, so long as the vehicle is in park, or turned off. It will be appreciated that numerous options exist for whether high conspicuity mode or standard mode takes priority and whether to allow for one activation switch or separate ones for each mode.

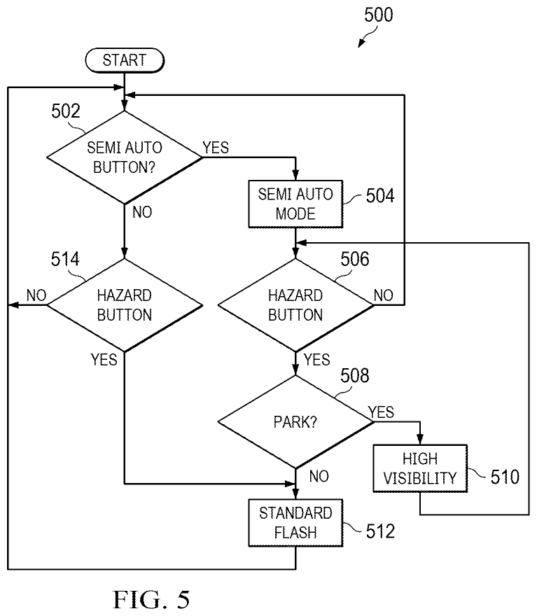

Referring now to FIG. 5, a flow chart 500 illustrating a semi-automatic functional mode of a high conspicuity vehicle lighting system according to aspects of the present disclosure is shown. When the system is powered, a button press may be detected at step 502 to place the system in semi-automatic mode at step 504. From this state, if the hazard button or switch is activated at step 506 the system may check at step 508 whether the vehicle is placed in Park. If so, high visibility or high conspicuity mode is activated at step 510. If the vehicle is not in Park as determined at step 508, standard flashers (e.g., 1-2 Hz cycle) are activated.

As can be seen, the control of the system in the illustrated embodiment only allows for activation of high visibility or high conspicuity mode if semi-auto mode has been activated (step 502), the hazard lights are turned on (step 506), and the vehicle is in park (step 512). If the vehicle is not in park only standard hazard flashers are deployed (step 512). As shown at step 514, standard hazard activation is detected at step 514 even if semi-auto mode is not active thus making at least standard flashers (e.g., step 512) available all the time.

It has been determined, as an additional benefit of a high conspicuity system according to the present disclosure, that systems of the present disclosure draw as little as 0.46 Amps compared to as much as 4.2 Amps in prior slow flashing incandescent systems. Quiescent draw of systems of the present disclosure (vehicle and lighting turned off) is as low as around 0.007 Amps.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
at least front and rear left turn signal lamps;
at least front and rear right turn signal lamps;
a microcontroller in operative control of the left and right turn signal lamps;
a park selector indicator input communicatively coupled to the microcontroller to indicate when a vehicle is placed in park;
an ignition switch position indicator communicatively coupled to the microcontroller to indicate when the vehicle ignition switch is on or off;
a hazard lamp switch that activates the microcontroller to flash the left and right turn signal lamps together a standard flash rate; and
a high conspicuity switch that activates the microcontroller to flash the left and right turn signal lamps together at a high conspicuity rate when the hazard lamp switch is activated, and the vehicle is in park or the ignition is off.

2. The system of claim 1, wherein the microcontroller comprises a body control module.

3. The system of claim 1, wherein the high conspicuity rate is perceptibly faster than the standard flash rate.

4. The system of claim 1, wherein the high conspicuity rate is 4 Hertz or more and the standard rate is 2 Hertz or less.

5. The system of claim 1, further comprising at least one auxiliary beacon on the vehicle that is activated by the microcontroller when the left and right turn signal lamps are activated at the high conspicuity rate.

6. The system of claim 5, wherein the at least one auxiliary beacon comprises at least one forward facing beacon on the vehicle and at least one rearward facing beacon on the vehicle.

7. The system of claim 5, wherein the at least one auxiliary beacon is flashed in synchronization with the left and right turn signal lamps.

8. A lighting system for use on a delivery vehicle comprising:
a set of signal lights including at least a left front signal lamp, a right front signal lamp, a left rear signal lamp, and a right rear signal lamp;
a microcontroller in operative control of the set of signal lights;
a gear shift lever that communicates when it is in a park position to the microcontroller;
an engine ignition switch that communicates when it is in an off state to the microcontroller;
a hazard light switch in operative communication with the microcontroller; and
a semi-automatic high conspicuity switch in operative communication with the microcontroller;
wherein the microcontroller, when it receives a first activation signal from the hazard light switch and a second activation signal from the semi-automatic high conspicuity switch, flashes the set of signal lights at a first, lower cycle rate if the gear shift lever is not in the park position and the engine ignition switch is not in the off state; and
wherein the microcontroller, when it receives the first activation signal from the hazard light switch and the second activation signal from the semi-automatic high conspicuity switch, flashes the set of signal lights at a second, higher cycle rate if the gear shift lever is in the park position or the engine ignition switch is in the off state.

9. The system of claim 8, wherein the microcontroller comprises a body control module of the delivery vehicle.

10. The system of claim 8, wherein the microcontroller has operative control of the set of vehicle lights by communicating with a body control module having control over the set of vehicle lights.

11. The system of claim 8, wherein the gear shift lever communicates when it is in a park position to the microcontroller via a controller area network bus (CANBUS).

12. The system of claim 11, wherein the engine ignition switch communicates when it is in an off state to the microcontroller via the CANBUS.

13. The system of claim 8, further comprising an auxiliary beacon activated by the microcontroller when the microcontroller flashes the set of signal lights at the second, higher cycle rate.

14. The system of claim 8, wherein the second, higher cycle rate is at least twice as fast as the first, lower cycle rate.

15. The system of claim 14, wherein the second higher cycle rate is at least 4 Hz.

16. The system of claim 8, wherein the semi-automatic high conspicuity switch is a soft switch.

17. A system comprising:
a set of signal lights including at least a left front signal lamp, a right front signal lamp, a left rear signal lamp, and a right rear signal lamp;
a microcontroller in operative control of the set of signal lights;
a gear shift lever that communicates when it is in a park position to the microcontroller;
a hazard light switch in operative communication with the microcontroller; and
a high conspicuity switch in operative communication with the microcontroller;
wherein the microcontroller, when it receives a first activation signal from the hazard light switch and a second activation signal from the high conspicuity switch, flashes the set of signal lights at a first, lower cycle rate if the gear shift lever is not in the park position;
wherein the microcontroller, when it receives the first activation signal from the hazard light switch and the second activation signal from the high conspicuity switch, flashes the set of signal lights at a second, higher cycle rate if the gear shift lever is in the park position; and
wherein the microcontroller, when it receives the first activation signal from the hazard light switch without the second activation signal from the high conspicuity switch, flashes the set of signal lights at the first, lower cycle rate regardless of input from the gear shift lever.

18. The system of claim 17, wherein:
the microcontroller comprises a body control module; and
the second, higher cycle rate is at least twice as fast as the first, lower cycle rate.

19. A system comprising:
a set of signal lights including at least a left front signal lamp, a right front signal lamp, a left rear signal lamp, and a right rear signal lamp;
a microcontroller in operative control of the set of signal lights;
an engine ignition switch that communicates when it is in an off state to the microcontroller a hazard light switch in operative communication with the microcontroller; and
a high conspicuity switch in operative communication with the microcontroller;
wherein the microcontroller, when it receives a first activation signal from the hazard light switch and a second activation signal from the high conspicuity switch, flashes the set of signal lights at a first, lower cycle rate if the engine ignition switch is not in the off state;
wherein the microcontroller, when it receives the first activation signal from the hazard light switch and the second activation signal from the high conspicuity switch, flashes the set of signal lights at a second, higher cycle rate if engine ignition switch is in the off state; and
wherein the microcontroller, when it receives the first activation signal from the hazard light switch without the second activation signal from the high conspicuity switch, flashes the set of signal lights at the first, lower cycle rate regardless of the off state of the ignition switch.

20. The system of claim 19, wherein:
the microcontroller comprises a body control module; and
the second, higher cycle rate is at least twice as fast as the first, lower cycle rate.
